(19) United States
(12) Patent Application Publication
(10) Pub. No.: US 2026/0054278 A1
(43) Pub. Date: Feb. 26, 2026

(54) SPRAY VALVE

(71) Applicant: HORNG TERNG AUTOMATION CO., LTD., KAOHSIUNG CITY (TW)

(72) Inventors: WEI-CHIEH WANG, KAOHSIUNG CITY (TW); SHAO-XUAN LU, KAOHSIUNG CITY (TW)

(21) Appl. No.: 19/273,353

(22) Filed: Jul. 18, 2025

(30) Foreign Application Priority Data
Aug. 22, 2024 (TW) 113131624

(51) Int. Cl. B05B 1/30

(52) U.S. Cl. CPC B05B 1/3066

(57) ABSTRACT

A spray valve has a valve body, a moving pin, an air-passage seat, and a nozzle structure. The moving pin is mounted within the valve body, is linearly movable relative to the valve body, and has an impact end. The air-passage seat has a connecting portion screwed onto the valve body and a positioning groove. The nozzle structure has a nozzle seat and a spray nozzle. The nozzle seat is movably accommodated in the positioning groove. The spray nozzle is in sliding fit with the nozzle seat and has a positioning conical portion. The positioning conical portion corresponds to the impact end of the moving pin and is configured to contact the impact end of the moving pin.

### BACKGROUND OF THE INVENTION

### 1. Field of the Invention

The present invention relates to a spray valve, and more particularly to a spray valve connected to dispensing equipment, configured to supply an adhesive, and used in a semiconductor bonding process.

### 2. Description of Related Art

A spray valve is configured to supply an adhesive, especially a liquid adhesive with low viscosity. The spray valve is connected to dispensing equipment and used in a semiconductor bonding process. The spray valve is able to atomize and spray the adhesives onto components, thereby bonding the components to each other.

A conventional spray valve comprises a valve body, a moving pin, and a spray nozzle. The valve body is connected to the dispensing equipment and has an adhesive storage passage. The spray nozzle is screwed onto a bottom of the valve body and has a mating groove and an adhesive outlet passage. The adhesive outlet passage extends downward from the mating groove. The moving pin is mounted through the adhesive storage passage of the valve body and can contact the mating groove of the spray nozzle.

During an adhesive dispensing operation, the moving pin moves upward and away from the spray nozzle. Subsequently, the dispensing equipment supplies the adhesive to the adhesive storage passage of the valve body. The moving pin moves downward and pushes the adhesive out of the adhesive storage passage of the valve body. When the adhesive dispensing operation is stopped, the moving pin abuts the mating groove and closes the adhesive outlet passage, thereby preventing the adhesive from flowing out of the adhesive outlet passage.

However, the spray nozzle is directly screwed onto the bottom of the valve body. A gap is maintained between a thread of the spray nozzle and a thread of the valve body to facilitate fastening. Thus, when the spray nozzle is rotated and screwed onto the valve body, the spray nozzle likely deflects in any direction. Furthermore, manufacturing errors may occur during manufacture of the valve body, the moving pin, and the spray nozzle, resulting in that the moving pin and the mating groove of the spray nozzle are not concentric. As a result, the moving pin cannot completely abut against the mating groove, such that a gap is formed and the adhesive outlet passage is not completely closed. Consequently, the adhesive may flow out of the adhesive outlet passage.

To avoid the above situation, when the spray nozzle is rotated and screwed onto the valve body, an operator has to rotate and adjust the spray nozzle repeatedly to ensure that the moving pin and the mating groove of the spray nozzle are actually concentric when assembly is completed. Therefore, it is inconvenient and highly time-consuming to assemble the spray valve.

### SUMMARY OF THE INVENTION

The main objective of the present invention is to provide a spray valve to overcome the defect that the moving pin and the spray nozzle are difficult to align concentrically in the conventional spray valve, thereby causing inconvenience and increasing assembly time.

The spray valve of the present invention has a valve body, a moving pin, an air-passage seat, and a nozzle structure.

The valve body has an outlet portion disposed at a bottom of the valve body. The outlet portion has a thread formed at a circumferential surface of the outlet portion.

The moving pin is mounted within the valve body, is linearly movable relative to the valve body, and has an impact end being conical and disposed at a bottom end of the moving pin.

The air-passage seat has a connecting portion and a positioning groove. The connecting portion is screwed onto the outlet portion of the valve body. The impact end of the moving pin is oriented toward the positioning groove.

The nozzle structure has a nozzle seat and a spray nozzle. The nozzle seat is movably accommodated in the positioning groove to form a gap between an outer surface of the nozzle seat and an inner wall of the positioning groove of the air-passage seat. The spray nozzle is in sliding fit with the nozzle seat to form an airflow space between the spray nozzle and the nozzle seat. The spray nozzle has an adhesive passage and a positioning conical portion. The adhesive passage extends through the spray nozzle. The positioning conical portion is formed at an end of the spray nozzle, fluidly communicates with the adhesive passage, corresponds to the impact end of the moving pin, and is configured to contact the impact end of the moving pin.

The spray valve of the present invention is configured to be connected to dispensing equipment and is used in a bonding process of semiconductor and electronic components. When assembling the spray valve, the nozzle seat and the spray nozzle of the nozzle structure are assembled together at first. Subsequently, the nozzle structure is accommodated in the positioning groove of the air-passage seat. Afterwards the air-passage seat and the nozzle structure are mounted together at the valve body, thereby completing the assembly of the present invention.

During an adhesive dispensing operation, the dispensing equipment supplies an adhesive to an interior of the valve body, then the moving pin pushes the adhesive into the adhesive passage of the spray nozzle. The spray valve can convey gas via the airflow space formed between the spray nozzle and the nozzle seat of the nozzle structure, thereby atomizing the adhesive sprayed from the adhesive passage of the spray nozzle.

The gap is formed between the outer surface of the nozzle seat and the inner wall of the positioning groove of the air-passage seat, such that the nozzle structure can move within the positioning groove of the air-passage seat. The positioning conical portion of the spray nozzle and the impact end of the moving pin are conical and correspond in shape. Therefore, when the connecting portion of the air-passage seat is screwed onto the outlet portion of the valve body, the nozzle structure can slightly move within the air-passage seat to position the moving pin and the positioning conical portion.

Consequently, manufacturing errors between different components are offset themselves. Moreover, the nozzle seat and the spray nozzle of the nozzle structure are assembled together via a sliding fit without being fixed together, such that the positioning conical portion of the spray nozzle and the impact end of the moving pin are concentric when the assembly of spray valve of the present invention is completed. Therefore, liquid adhesives with low viscosity are prevented from flowing out of the adhesive passage of the spray nozzle when the adhesive supply is stopped.

The moving pin and the positioning conical portion of the spray nozzle correspond in shape, and the gap is formed between the air-passage seat and the nozzle seat. Therefore, when the assembly of the spray valve is completed, the spray nozzle and the moving pin are concentric. As a result, repeated adjustment is unnecessary during assembly, thereby improving assembly convenience. Even if manufacturing defects of the moving pin and the nozzle structure occur, the moving pin and the spray nozzle are concentric when the assembly is completed, thereby lowering requirement for manufacturing precision and reducing production costs.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a spray valve in accordance with the present invention;

FIG. 2 is a partially exploded perspective view of the spray valve in FIG. 1;

FIG. 3 is a partially cross-sectional side view of the spray valve in FIG. 1;

FIG. 4 is an enlarged partially cross-sectional side view of the spray valve in FIG. 1;

FIG. 5 is an exploded perspective view of a nozzle structure of the spray valve in FIG. 1;

FIG. 6 is a top view of the nozzle structure in FIG. 5; and

FIG. 7 is a cross-sectional side view of the nozzle structure across line 7-7 in FIG. 6.

### DETAILED DESCRIPTION OF THE PREFERRED EMBODIMENTS

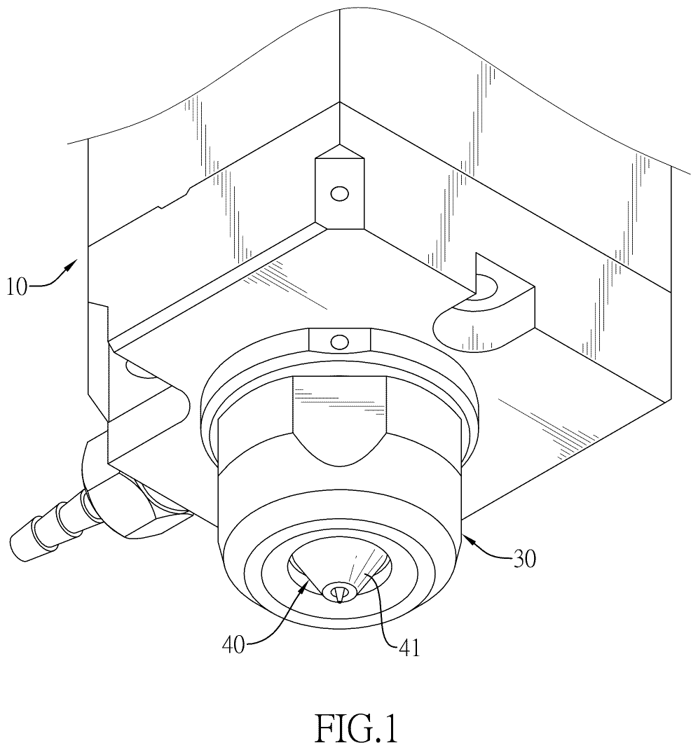

With reference to FIGS. 1 to 3, a spray valve in accordance with the present invention comprises a valve body 10, a moving pin 20, an air-passage seat 30, and a nozzle structure 40.

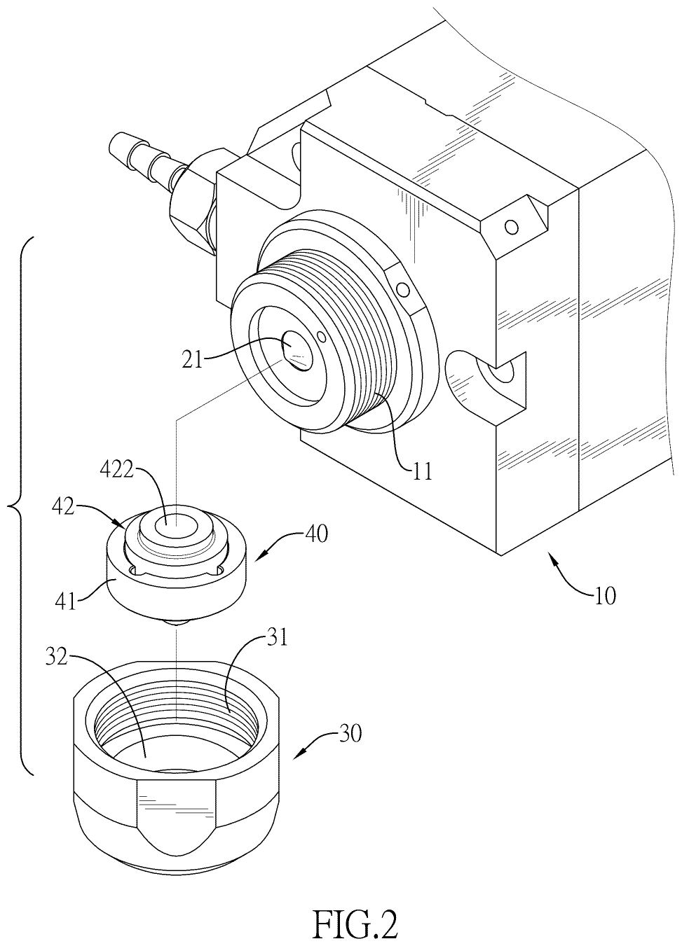

With reference to FIG. 2, the valve body 10 has an outlet portion 11 disposed at a bottom of the valve body 10. The outlet portion 11 has a thread formed at a circumferential surface of the outlet portion 11.

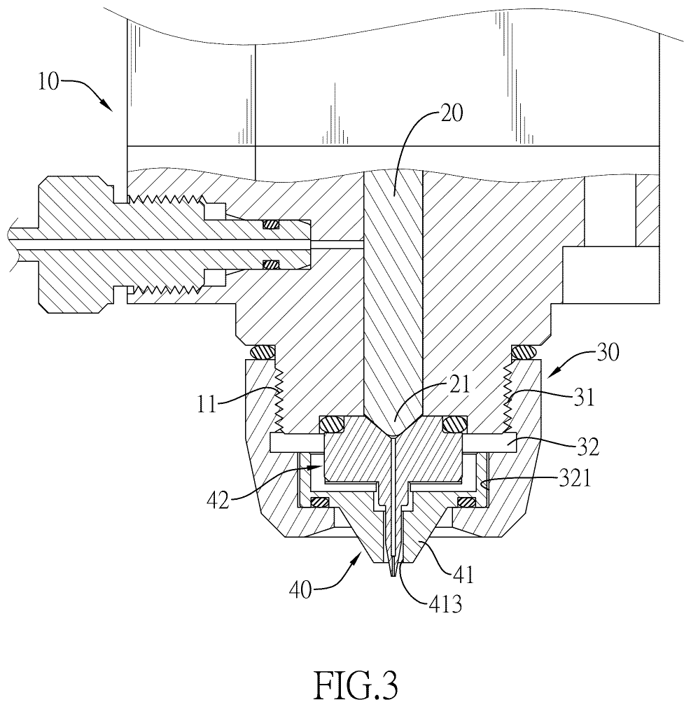

With reference to FIGS. 2 and 3, the moving pin 20 is mounted within the valve body 10, is linearly movable relative to the valve body 10, and has an impact end 21 being conical.

With reference to FIGS. 2 and 3, the air-passage seat 30 has a connecting portion 31 and a positioning groove 32. The connecting portion 31 is screwed onto the outlet portion 11 of the valve body 10. The impact end 21 of the moving pin 20 is oriented toward the positioning groove 32.

With reference to FIGS. 3 to 5, the nozzle structure 40 has a nozzle seat 41 and a spray nozzle 42. The nozzle seat 41 is movably accommodated in the positioning groove 32 to form a gap between an outer surface of the nozzle seat 41 and an inner wall 321 of the positioning groove 32 of the air-passage seat 30. The spray nozzle 42 is in sliding fit with the nozzle seat 41 to form an airflow space between the spray nozzle 42 and the nozzle seat 41. The spray nozzle 42 has an adhesive passage 421 and a positioning conical portion 422. The adhesive passage 421 extends through the spray nozzle 42. The positioning conical portion 422 is formed at an end of the spray nozzle 42, fluidly communicates with the adhesive passage 421, corresponds to the impact end 21 of the moving pin 20, and is configured to contact the impact end 21 of the moving pin 20. Wherein, the positioning conical portion 422 of the spray nozzle 42 is conically formed in the end of the spray nozzle 42. The positioning conical portion 422 is a conical pit, and the impact end 21 of the moving pin 20 is conical. The positioning conical portion 422 and the impact end 21 correspond to each other in shape and have corresponding tapers.

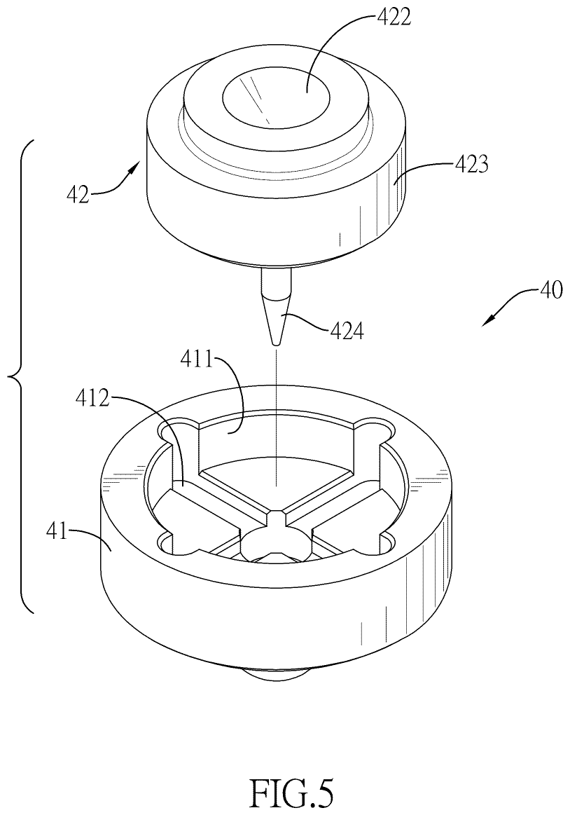

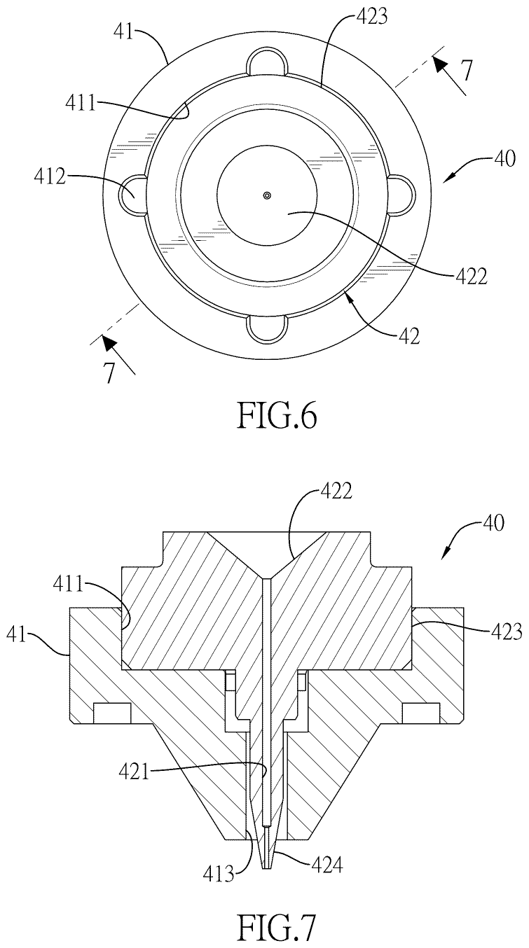

The spray valve of the present invention is configured to be connected to dispensing equipment and is used in a bonding process of semiconductor and electronic components. When assembling the spray valve, the nozzle seat 41 of the nozzle structure 40 and the spray nozzle 42 are assembled together at first.

Wherein, with reference to FIGS. 5 to 7, the spray nozzle 42 has an outer annular wall 423. The nozzle seat 41 has a mating groove 411 formed therewithin. A diameter of the outer annular wall 423 corresponds to an internal diameter of the mating groove 411, such that the outer annular wall 423 of the spray nozzle 42 is in sliding fit with the mating groove 411.

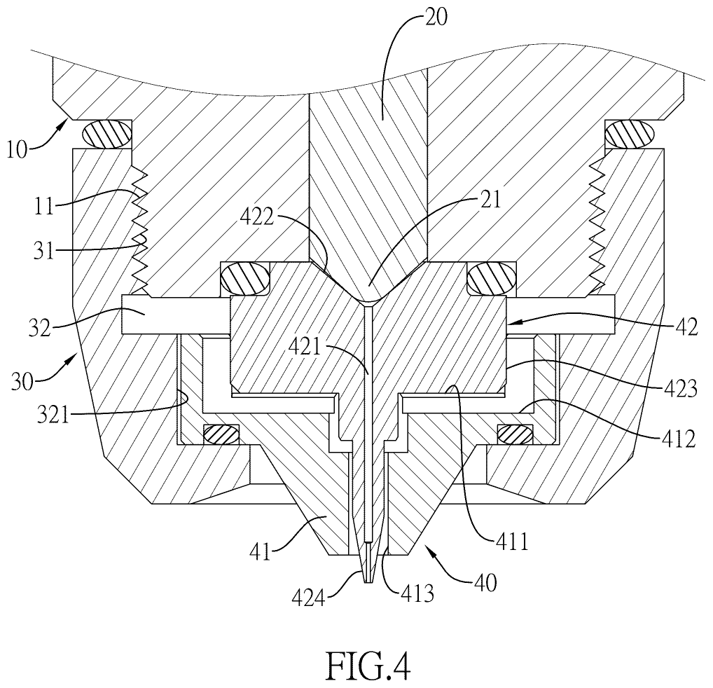

Subsequently, with reference to FIGS. 3 and 4, the nozzle structure 40 is accommodated in the positioning groove 32 of the air-passage seat 30 to form the gap between the outer surface of the nozzle seat 41 and the inner wall 321 of the positioning groove 32 of the air-passage seat 30, and hence the nozzle structure 40 can slightly move forward, backward, leftward, and rightward relative to the air-passage seat 30. When the connecting portion 31 of the air-passage seat 30 is screwed onto the outlet portion 11 of the valve body 10, the air-passage seat 30 abuts against the nozzle seat 41, such that the spray nozzle 42 is abutted and positioned between the nozzle seat 41 and the valve body 10. Accordingly, the air-passage seat 30 and the nozzle structure 40 are mounted together at the valve body 10, thereby completing the assembly of the present invention.

During an adhesive dispensing operation, the dispensing equipment supplies an adhesive to an inside of the valve body 10, and then the moving pin 20 pushes the adhesive into the adhesive passage 421 of the spray nozzle 42. The spray valve can convey gas via the airflow space formed between the spray nozzle 42 and the nozzle seat 41 of the nozzle structure 40, thereby atomizing the adhesive sprayed from the adhesive passage 421 of the spray nozzle 42.

Wherein, with reference to FIGS. 3 to 6, the nozzle seat 41 has an airflow channel structure 412 and a jet channel 413. The airflow space is formed by the airflow channel structure 412 and the jet channel 413. The airflow channel structure 412 is located at a top of the nozzle seat 41 and fluidly communicates with the mating groove 411. The jet channel 413 extends through the nozzle seat 41 and fluidly communicates with the airflow channel structure 412. The outer annular wall 423 of the spray nozzle 42 is adjacent to the airflow channel structure 412. The spray nozzle 42 has a spray end 424 sequentially mounted through the airflow channel structure 412 and the jet channel 413, such that the jet channel 413 surrounds an outer surface of the spray end 424. The spray valve can convey gas to the spray end 424 via the airflow channel structure 412 and the jet channel 413, thereby atomizing the adhesive passing through the spray nozzle 42.

When the spray valve is assembled, with reference to FIGS. 4 to 6, the nozzle structure 40 can move within the positioning groove 32 via the gap between the nozzle seat 41 and the positioning groove 32 of the air-passage seat 30. The positioning conical portion 422 of the spray nozzle 42 and the impact end 21 of the moving pin 20 are conical and correspond in shape. Therefore, when the connecting portion 31 of the air-passage seat 30 is rotated and screwed onto the outlet portion 11 of the valve body 10, the nozzle structure 40 can automatically offset inside the air-passage seat 30 to eliminate manufacturing errors between different components via a conical positioning between the moving pin 20 and the positioning conical portion 422. Furthermore, the nozzle seat 41 and the spray nozzle 42 of the nozzle structure 40 are assembled together via a sliding fit without being fixed together, such that the positioning conical portion 422 of the spray nozzle 42 and the impact end 21 of the moving pin 20 remain concentric during assembly and still remain concentric after the spray valve assembly is completed. Accordingly, when the impact end 21 of the moving pin 20 abuts against the positioning conical portion 422 of the spray nozzle 42, the adhesive passage 421 of the spray nozzle 42 can be actually closed, thereby preventing the adhesive from flowing out of the adhesive passage 421 of the spray nozzle 42 when the adhesive supply is stopped.

The moving pin 20 and the positioning conical portion 422 of the spray nozzle 42 correspond in shape, and the gap is formed between the air-passage seat 30 and the nozzle seat 41. Therefore, when the spray valve assembly is completed, the spray nozzle 42 and the moving pin 20 are concentric by themselves. As a result, adjusting repeatedly is unnecessary during assembly, thereby improving assembly convenience. Even if differing in concentricity during manufacturing, the moving pin 20 and the spray nozzle 42 will be concentric when assembly is completed, thereby reducing required manufacturing precision and lowering production costs.

In conclusion, the spray valve of the present invention is configured to spray atomized adhesives, especially liquid adhesives with low viscosity. In the present invention, the moving pin 20 and the positioning conical portion 422 of the spray nozzle 42 correspond in shape, and the gap is formed between the air-passage seat 30 and the nozzle seat 41. Therefore, when assembling the spray valve, the nozzle structure 40 can move itself inside the air-passage seat 30 to eliminate manufactural errors between different components. As a result, when assembly is completed, the spray nozzle 42 and the moving pin 20 are concentric by themselves, and the moving pin 20 abuts against the positioning conical portion 422 of the spray nozzle 42 to close an adhesive passage 421 of the spray nozzle 42, thereby improving assembly convenience and reducing assembly time.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A spray valve comprising:
a valve body having
a bottom; and
an outlet portion disposed at the bottom of the valve body and having a thread formed at a circumferential surface of the outlet portion;
a moving pin mounted within the valve body, linearly movable relative to the valve body, and having an impact end being conical and disposed at a bottom end of the moving pin;
an air-passage seat having
a connecting portion screwed onto the outlet portion of the valve body; and
a positioning groove, the impact end of the moving pin oriented toward the positioning groove; and
a nozzle structure having
a nozzle seat movably accommodated in the positioning groove to form a gap between an outer surface of the nozzle seat and an inner wall of the positioning groove of the air-passage seat; and
a spray nozzle in sliding fit with the nozzle seat to form an airflow space between the spray nozzle and the nozzle seat, wherein the spray nozzle has
an adhesive passage extending through the spray nozzle; and
a positioning conical portion formed at an end of the spray nozzle, fluidly communicating with the adhesive passage, corresponding to the impact end of the moving pin, and configured to contact the impact end of the moving pin.

2. The spray valve as clamed in claim 1, wherein when the connecting portion of the air-passage seat is screwed onto the outlet portion of the valve body, the air-passage seat abuts against the nozzle seat, such that the spray nozzle is abutted and positioned between the nozzle seat and the valve body.

3. The spray valve as clamed in claim 2, wherein
the spray nozzle has an outer annular wall;
a mating groove is formed inside the nozzle seat; and
a diameter of the outer annular wall corresponds to an internal diameter of the mating groove, such that the outer annular wall of the spray nozzle is in sliding fit with the mating groove.

4. The spray valve as clamed in claim 1, wherein
the nozzle seat has a jet channel extending through the nozzle seat;
the spray nozzle has a spray end mounted through the jet channel; and
the jet channel surrounds an outer surface of the spray end.

5. The spray valve as clamed in claim 2, wherein
the nozzle seat has a jet channel extending through the nozzle seat;
the spray nozzle has a spray end mounted through the jet channel; and
the jet channel surrounds an outer surface of the spray end.

6. The spray valve as clamed in claim 3, wherein
the nozzle seat has a jet channel extending through the nozzle seat;
the spray nozzle has a spray end mounted through the jet channel; and
the jet channel surrounds an outer surface of the spray end.

7. The spray valve as clamed in claim 1, wherein
the nozzle seat has an airflow channel structure located at a top of the nozzle seat and fluidly communicating with both the top and a bottom of the nozzle seat; and
the spray nozzle has a spray end mounted through the airflow channel structure.

8. The spray valve as clamed in claim 2, wherein
the nozzle seat has an airflow channel structure located at a top of the nozzle seat and fluidly communicating with both the top and a bottom of the nozzle seat; and
the spray nozzle has a spray end mounted through the airflow channel structure.

9. The spray valve as clamed in claim 3, wherein
the nozzle seat has an airflow channel structure located at a top of the nozzle seat and fluidly communicating with both the top and a bottom of the nozzle seat;
the airflow channel structure fluidly communicates with the mating groove and is adjacent to the outer annular wall of the spray nozzle; and
the spray nozzle has a spray end mounted through the airflow channel structure.

10. The spray valve as clamed in claim 4, wherein
the nozzle seat has an airflow channel structure located at a top of the nozzle seat and fluidly communicating with the jet channel; and
the spray end is sequentially mounted through the airflow channel structure and the jet channel.

11. The spray valve as clamed in claim 5, wherein
the nozzle seat has an airflow channel structure located at a top of the nozzle seat and fluidly communicating with the jet channel; and
the spray end is sequentially mounted through the airflow channel structure and the jet channel.

12. The spray valve as clamed in claim 6, wherein
the nozzle seat has an airflow channel structure located at a top of the nozzle seat and fluidly communicating with the jet channel; and
the spray end is sequentially mounted through the airflow channel structure and the jet channel.

13. The spray valve as clamed in claim 1, wherein
the positioning conical portion of the spray nozzle is conically formed in the end of the spray nozzle, and
a taper of the positioning conical portion corresponds to a taper of the impact end.

14. The spray valve as clamed in claim 2, wherein
the positioning conical portion of the spray nozzle is conically formed in the end of the spray nozzle, and
a taper of the positioning conical portion corresponds to a taper of the impact end.

15. The spray valve as clamed in claim 3, wherein
the positioning conical portion of the spray nozzle is conically formed in the end of the spray nozzle, and
a taper of the positioning conical portion corresponds to a taper of the impact end.

16. The spray valve as clamed in claim 10, wherein
the positioning conical portion of the spray nozzle is conically formed in the end of the spray nozzle; and
a taper of the positioning conical portion corresponds to a taper of the impact end.

17. The spray valve as clamed in claim 11, wherein
the positioning conical portion of the spray nozzle is conically formed in the end of the spray nozzle; and
a taper of the positioning conical portion corresponds to a taper of the impact end.

18. The spray valve as clamed in claim 12, wherein
the positioning conical portion of the spray nozzle is conically formed in the end of the spray nozzle; and
a taper of the positioning conical portion corresponds to a taper of the impact end.

19. A spray valve comprising:
a valve body having
a bottom; and
an outlet portion disposed at the bottom of the valve body and having a thread formed at a circumferential surface of the outlet portion;
a moving pin mounted within the valve body, linearly movable relative to the valve body, and having an impact end being conical and disposed at a bottom end of the moving pin;
an air-passage seat having
a connecting portion screwed onto the outlet portion of the valve body; and
a positioning groove, the impact end of the moving pin oriented toward the positioning groove; and
a nozzle structure having
a nozzle seat movably accommodated in the positioning groove to form a gap between an outer surface of the nozzle seat and an inner wall of the positioning groove of the air-passage seat, and having a mating groove formed inside the nozzle seat; and
a spray nozzle in sliding fit with the nozzle seat to form an airflow space between the spray nozzle and the nozzle seat, wherein the spray nozzle has
an outer annular wall, wherein a diameter of the outer annular wall corresponds to an internal diameter of the mating groove, such that the outer annular wall of the spray nozzle is in sliding fit with the mating groove;
an adhesive passage extending through the spray nozzle; and
a positioning conical portion formed at an end of the spray nozzle, fluidly communicating with the adhesive passage, corresponding to the impact end of the moving pin, and configured to contact the impact end of the moving pin.

20. The spray valve as clamed in claim 19, wherein
the positioning conical portion of the spray nozzle is conically formed in the end of the spray nozzle, and
a taper of the positioning conical portion corresponds to a taper of the impact end.
